(19) United States
(12) Patent Application Publication
(10) Pub. No.: US 2008/0284605 A1
(43) Pub. Date: Nov. 20, 2008

(54) Automated Tuning Method for Rfid Labels

(76) Inventors: Gary Mark Shafer, Charlotte, NC (US); Richard L. Copeland, Lake Worth, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 11/908,123

(22) PCT Filed: Mar. 6, 2006
(86) PCT No.: PCT/US06/07884

§ 371 Date: Apr. 28, 2008

Related U.S. Application Data
(60) Provisional application No. 60/659,380, filed on Mar. 7, 2005.
(60) Provisional application No. 60/659,289, filed on Mar. 7, 2005.

(51) Int. Cl. G08B 13/14

(52) U.S. Cl. 340/572.7

(57) ABSTRACT

A method and an analogous system for tuning an RFID label prior to application to an article are disclosed. The method includes providing an RFID label having at least one antenna disposed therein, identifying an article, relaying information related to the identification of the article to a controller, with the controller including a memory of predetermined tuning parameters for the article, retrieving from memory one or more of the tuning parameters for the article; and adjusting the tuning parameters of the RFID label to correspond to the article by altering a geometric parameter of the antenna of the RFID label. The system includes a cutting device to alter a geometric parameter to correspond to the article by removing material from at least one antenna forming part of the RFID label.

### CROSS-REFERENCE TO RELATED APPLICATIONS

This application claims the benefit of priority of U.S. Provisional Patent Application Ser. No. 60/659,289 by Shafer et al, entitled “AUTOMATED TUNING METHOD FOR RFID LABELS, filed on Mar. 7, 2005; and U.S. Provisional Patent Application Ser. No. 60/659,380 by Copeland et al, entitled “LINEAR MONOPOLE MICROSTRIP RFID NEAR FIELD ANTENNA”, filed on Mar. 7, 2005.

### BACKGROUND

The range performance of radiofrequency identification (RFID) labels is strongly affected by the characteristics of the material upon which they are mounted (e.g., the product substrate material). This material might be metal, glass, fiberboard, or paper, for example. These materials exhibit widely different conductivity relative permittivity, and loss tangent. Unless the RFID label can be tuned for each substrate, the read-range performance may not be optimized and may exhibit large variations between substrates. In some cases the read-range can be almost zero. To overcome this limitation, it is desirable to alter some physical parameter of the label such as antenna conductor length, or width, or both in order to achieve optimum tuning for placement on a particular product substrate.

A solution often used in industry is to design a label antenna for each particular product optimized in terms of tuning and range performance.

Using a different label for each product substrate adds cost due to the requirement of maintaining a large number of different label types as well as lowering the economy-of-scale.

### SUMMARY

The present invention relates to a method for tuning an RFID label prior to application to an article. The method may include the steps of: providing an RFID label having at least one antenna disposed therein, identifying an article; and relaying information related to the identification of the article to a controller. The controller may include a memory of pre-determined tuning parameters for the article. The method further includes the steps of retrieving from memory one or more of the tuning parameters for the article; and adjusting the tuning parameters of the RFID label to correspond to the article by altering at least one geometric parameter of the at least one antenna of the RFID label. The step of altering at least one geometric parameter may include altering at least one of a length, a width, and a depth of the at least one antenna of the RFID label. The step of altering at least one geometric parameter may be performed by at least one of mechanically cutting; punching; and ablating.

The method may further include the steps of: measuring a response of the RFID label; providing feedback to the controller to further adjust the tuning parameter by further altering at least one geometric parameter of the at least one antenna; and repeating the measuring step until a desired tuning is achieved.

In one embodiment, the step of retrieving one or more of said tuning parameters for the article may be performed by reading the RFID label via a near field antenna assembly. As previously disclosed by the same authors in various patent applications filed, the near field antenna localizes a single RFID label without affecting nearby or adjacent labels so that only one antenna can be interrogated at a time.

The method may be implemented wherein following the step of providing an RFID label having at least one antenna disposed therein, the method further includes the step of providing a laser for altering at least one geometric parameter of the at least one antenna. Also, the method may be implemented by simply cutting the antenna using a punch or knife device such that the antenna ends are modified to allow the RFID label frequency to be tuned to the correct frequency when mounted on a given object.

The present invention relates also to a system for tuning an RFID label prior to application to an article. The system includes a controller which receives identifying information on the article. The controller has a memory of pre-determined tuning parameters for the article and retrieves from memory one or more of the tuning parameters for the article. The system also includes a cutting device configured to adjust the tuning parameters of the RFID label to correspond to the article by removing material from at least one antenna forming part of the RFID label.

The system may further include an article identification vision system which provides the identifying information to the controller and a tuning indicator measuring response of the RFID label and providing feedback to the controller to further adjust the tuning parameter by removing additional material from the at least one antenna. The tuning indicator may be operatively coupled to a near field antenna which is in proximity to the tag such that the near field antenna measures the response of the tag. In one embodiment, the near field antenna may include a linear monopole microstrip assembly. In one embodiment, the near field antenna may include a meanderline monopole microstrip assembly.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a top view of a RFID tag with an antenna having tunable segment points in accordance with one embodiment of the present invention;

FIG. 2 is a schematic process diagram illustrating an automated tuning method for RFID labels in accordance with one embodiment of the present invention;

FIG. 3 is method block diagram for the automated tuning method for RFID labels according to FIG. 2;

FIG. 4 illustrates a top perspective view of one embodiment of a proximity antenna assembly or near field antenna assembly having a linear microstrip configuration according to the present invention with an RFID label overhead; and

FIG. 5 illustrates a top perspective view of one embodiment of a proximity antenna assembly or near field antenna assembly having a meanderline microstrip configuration according to the present invention with an RFID label overhead.

### DETAILED DESCRIPTION

The present invention will be understood more fully from the detailed description given below and from the accompanying drawings of particular embodiments of the invention which, however, should not be taken to limit the invention to a specific embodiment but are for explanatory purposes.

Numerous specific details may be set forth herein to provide a thorough understanding of a number of possible embodiments of the present invention. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments disclosed herein are not necessarily limited in this context.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

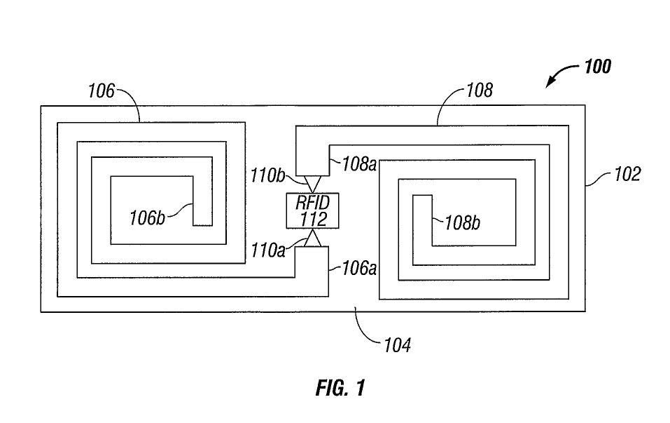

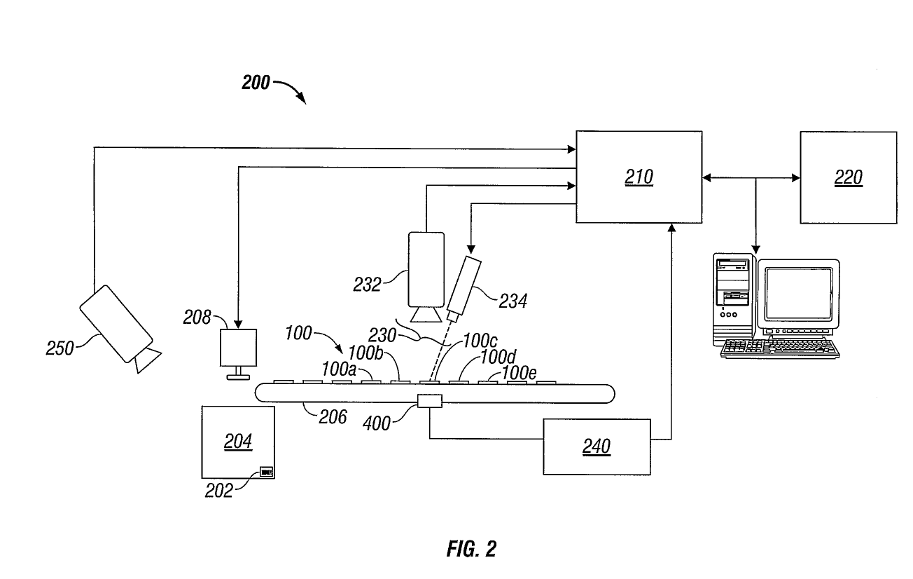

Turning now to the details of the present invention, FIGS. 1 and 2 illustrate a tunable RFID label 100 and a system 200 to automatically tune the label 100 before it is applied to a product 202. The system 200 in general may include a sensor or some other type of mechanism which is configured to recognize which product 202 is being labeled and a mechanism (farther described below) which is configured to automatically tune each label 100 for optimum performance on the particular product 202. In the method described here, the tunable label 100 may be viewed by a camera vision system, described below.

Referring to FIG. 1, the RFID tunable label 100 may include an antenna 102 having a first antenna portion 106. The first antenna portion 106 may have a first antenna end 106a and a second antenna end 106b. Similarly, a second antenna portion 108 may have a first antenna end 108a and a second antenna end 108b. In one embodiment, first antenna end 106a of first antenna portion 106 may be connected to a lead frame 110a. First antenna portion 106 may be disposed on a substrate 104 to form an inwardly spiral pattern from an RFID chip 112, which may be an application specific integrated circuit (ASIC)-based logic circuit or processing chip. The second antenna end 106b may be positioned to terminate on the inner loop of the inwardly spiral pattern. Similarly, first antenna end 108b of second antenna portion 108 may be connected to a lead frame 110b. Second antenna portion 108 may be also disposed on substrate 104 to form an inwardly spiral pattern from RFID chip 112 in a second direction, with second antenna end 108b positioned to terminate on the inner loop of the inwardly spiral pattern. In one envisioned embodiment, the antenna geometry of antenna 102 may be configured to traverse around the perimeter of substrate 104 and spiral inwardly.

It is envisioned that by trimming the ends 106b and 108b at the inner loops of the inwardly spiral conductor pattern of RFID label 100, the operating frequency of the RFID label 100 may be selectively tuned for a specific procedure. Typically, the antenna is manufactured with the longest length deemed necessary corresponding to the lowest frequency of operation expected in actual use. Removing material raises the operating frequency and or compensates for loading due to the material on which the label is mounted. This allows coverage of a wide range of operating frequencies and loading situations. The tuning of antenna 102 for UHF applications is disclosed in further detail in co-pending, commonly owned U.S. patent application Ser. No. 10/917,752 filed on Aug. 13, 2004 entitled “TUNABLE ANTENNA” by R. Copeland and G. M. Shafer, the entire contents of which is incorporated by reference herein.

FIG. 2 discloses an RFID label applicator system 200 which may include a label applicator machine that may be used to apply RFID labels 100 to various products or articles 202, before the products or articles 202 are packaged for shipment in a product package 204. The RFID label applicator system typically may include a conveyor belt 206, an applicator head 208, and a controller 210. The various functions of the controller 210 may be performed by a central processing unit (CPU), which may be a desktop computer or similar electronic device, having memory storage 220 which is coupled to the controller 210.

To provide automatic tuning of the RFID labels 100 in accordance with the present invention, the RFID label applicator system 200 may include an RFID label tuning vision system 230. The RFID label tuning vision system 230 may include a camera 232 and a cutting device 234, which may include, but is not limited to, at least one of a mechanical device such as a blade configured for cutting out or a punch press for punching out a portion of material, or a remote device such as a laser or an electron beam configured for ablating a portion of material. Label 100 is selectively and, in one embodiment, automatically tuned by removing a specified amount of antenna material, thereby altering a geometric parameter of the RFID label 100. Removing material from ends 106b and/or 108b alters the geometric parameter of length of the RFID label 100. Other geometric parameters of the RFID label 100 which may be altered by removing material include the width or the depth of the RFID label 100. The embodiments are not limited in this context. Further altering of one or more of the geometric parameters continues by removing material until the required tuning response from the label 100 is attained. In some applications, it may be desired to add material or to change at least a portion of the material of antenna 102. The embodiments are not limited in this context. The CPU may include one or more algorithms or look-up tables as to initially determine the appropriate amount of material which needs to be removed to acquire the desired tuning effect. The cutting device 234 is configured to remove material from the tunable antenna 102 at second ends 106b and 108b of first antenna portion 106 and second antenna portion 108, respectively.

The RFID label applicator system 200 may further include a tuning indicator 240 which is coupled to a proximity antenna or near field antenna 400. The tuning indicator 240, in conjunction with the near field antenna 400, measures the tuned response of the label 100 and provides feedback to the controller 210, thus closing the loop between the altered parameter, e.g., the product identification number or serial number, and the response of the label 100.

The RFID label applicator system 200 may further include an article or product identification (ID) vision system 250 which includes a camera to observe the product 202. The article or product ID vision system 250 relays data to the controller 210 concerning what product or article 202 is being labeled. Therefore, the controller 210 receives the identifying information and, based on the identifying information, determines the degree of adjustment necessary to the tunable label antenna 102 in order to optimize the performance, e.g., to verify the accuracy of the product identification number, batch number, and/or serial number being applied.

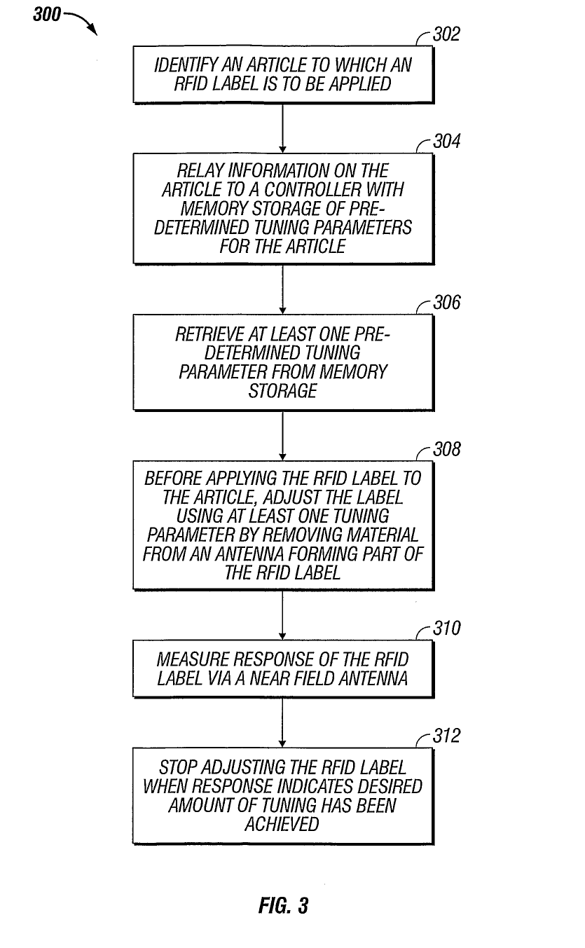

FIG. 3 discloses a flow chart which describes one method 300 according to the present invention that enables the selective and automatic tuning of RFID labels 100 before applying the labels 100 to an article or product 202. More particularly, upon providing an RFID label 100 having at least one antenna 102 disposed therein, method 300 may include the step 302 of identifying the article or product 202 to which one of the RFID labels 100 is to be applied before applying the label 100 to the article or product 202, via typically, but not limited to, observation by a product ID vision system 220. Once the article or product 202 has been identified, the method may include the step 304 of relaying the information regarding the identification of the article or product 202 to the controller 210. The controller 210 may include a memory 220 with pre-determined tuning parameters for all of the articles or products 202 stored in the memory 220. Step 306 may include retrieving, via the controller 210, at least one correct predetermined tuning parameter from the memory 220 for the particular article or product 202 being observed.

Step 308 may include, adjusting, via the controller 210, the at least one tuning parameter of the RFID label 100 to correspond to the article or product 202 by removing material from the antenna 102 forming part of the RFID label 100. The controller 210 may use the information stored in memory to adjust the label 100 to suit the article or product 202. The method may be implemented by the cutting the antenna 102 using cutting device 234 in the form of a punch or knife device such that the antenna ends 106b and 108b are modified to allow the frequency of the RFID label 100 to be tuned to the correct frequency when mounted on a given object. Thereby, a geometric parameter of the antenna 102, e.g., a length, a width, and/or a depth of the antenna 102 is/are altered by the step 308 of removing material.

Step 310 may include measuring the response of the RFID label 100 via tuning indicator 240 and the near field antenna 400. Step 312 may include ceasing or stopping the tuning of the RFID label 100 once the desired tuning effect has been achieved.

As can be appreciated, the general approach of method 300 is such that the controller 210 directs the tuning system, which may include the tuning indicator 240, the near field antenna 400, and the RFID label tuning vision system 230. The RFID label tuning vision system 230 may include both cutting device 234, which removes material from the antenna 102 until the antenna 102 provides the required response for the particular article or product 202, and camera 232. The tuning indicator 240 may provide feedback to the controller 210 to further adjust the tuning parameters by removing additional material from the at least one antenna 102. The step 310 of measuring the response of the RFID label 100 via tuning indicator 240 and the near field antenna 400 may be repeated until a desired tuning effect has been achieved.

The article or product ID vision system 250 observes the label 100 and may direct the cutting device 234 to the proper location on the label 100 to remove material from the label antenna surface, such as by laser ablation. The tuning indicator 240 instantaneously measures the response of the label 100 and provides feedback to the controller 210. When the desired amount of tuning is achieved, the controller 210 may stop the process and the label 100 is ready to be applied to the article or product 202.

The method 300 of the present invention provides a fully automatic system to apply labels with the correct read-range performance for the product being labeled. Only one type of label need be purchased in bulk quantity since the label will be modified for optimum performance during the application process. As new products are introduced, the parameter list can be updated with new tuning parameters particular to the new product thus allowing one type of tunable label to be used for a wide variety of products. In prior solutions, different labels were applied depending upon the type of product or the label vendor pre-tuned the label at the point of manufacture and delivered this pre-tuned label to the customer applying the labels. Either of these prior methods requires forecasting quantities of product leading to waste and higher costs.

The method described herein allows the use of a single type of tunable label to be stocked by a customer applying labels to products. All product parameters are known by the system and the system can adjust labels as required to optimize performance. As new products or articles are introduced, the parameter list can be updated with new tuning information about that particular product or article. Prior methods required maintaining stocks of labels optimized for each product as well as forecasting the needs in the future. This increases the cost of use.

In one embodiment, according to the present invention, the tuning system, which may include the tuning indicator 240, the near field antenna 400, and the RFID label tuning vision system 230, may be used in an automated fashion or with an operator who manually selects the correct tuning parameters from the parameter list stored in the memory 220 of the controller 210. As a result, use of the article or product ID vision system 250 to identify products may be optional. In one embodiment, the tuning indicator 240 may be excluded from the system 200, especially if the information stored in the controller 210 is highly accurate.

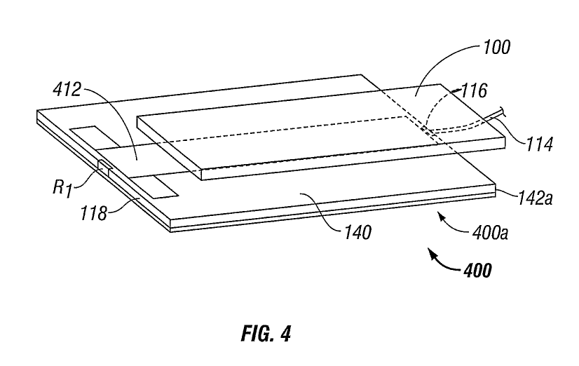

The proximity antenna or near field antenna 400 may be a near field antenna assembly for reading the RFID label 100. For example, and as illustrated in FIG. 4, the near field antenna assembly 400 may be configured so that the electric field is localized just above the antenna surface in the near field. For example, the near field antenna assembly 400 can operate typically at a frequency of about 915 MHz such that the near field zone distance is about 5 cm. The proximity or near field antenna 400 localizes a single RFID label, e.g., label 100c, without affecting nearby or adjacent labels, e.g., labels 100a, 100b, 100d or 100e, so that only one RFID label, e.g., label 100c, can be interrogated at a time (see FIG. 2).

As illustrated specifically in FIG. 4, the proximity antenna or near field antenna assembly 400 may include a linear monopole microstrip near field antenna assembly 400a. The near field antenna assembly 400a may include a linear monopole microstrip antenna 412 disposed on a substrate 140 with a large RFID label 100 in proximity overhead. The microstrip antenna 412 may be electrically coupled to a cable 114, which may be a coaxial cable, at a feed point end 116 and terminated into a terminating resistor R1, which may be 50 ohms, at an opposite or termination end 118. A signal is fed at the feed point end 116 from the cable 114

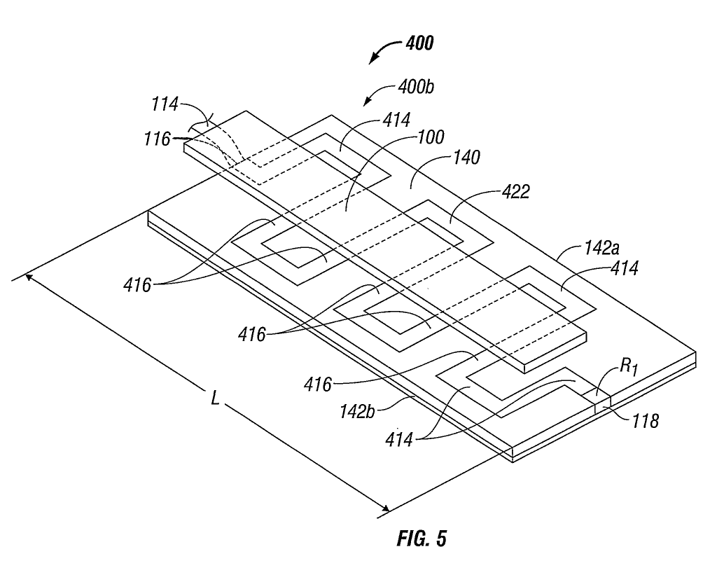

As illustrated specifically in FIG. 5, the proximity antenna or near field antenna assembly 400 may include a near field antenna assembly 400b which may include a meanderline monopole microstrip antenna 422. The antenna 422 “meanders” across the width WS of the substrate 140 as it proceeds along the length L from the feed point 116 to the terminating resistor R1 at the termination end 118.

The meanderline microstrip antenna 422 may be electrically coupled to cable 114 at feed point end 116 and terminated into the terminating resistor R1 at termination end 118.

The meanderline microstrip antenna 422 differs from linear microstrip antenna 412 in that the meanderline microstrip assembly 400b may have a length that is greater than the straightline distance from feed point end 116 to termination end 118. Meanderline microstrip assembly 400b may include a plurality of alternating orthogonally contacting conducting segments 414 and 416, respectively, configured in a square wave pattern forming the meanderline microstrip antenna 422. Conducting segments 414 may be linearly aligned with the length L and substantially parallel to at least one of the lengthwise side edges 142a and 142b of the substrate 140. Conducting segments 416 may be transversely aligned to and in contact with the linearly aligned conducting segments 414 to form the square wave pattern. In one embodiment, the contacting conducting segments 414 and 416 may be integrally formed of a unitary microstrip.

Such near field antennas 400 are described in co-pending PCT Application Serial No. PCT/US 05/35595 by Shafer et al, entitled “RFID NEAR FIELD MICROSTRIP ANTENNA”, the entire contents of which is incorporated herein by reference.

While the above description contains many specifics, these specifics should not be construed as limitations on the scope of the present invention, but merely as exemplifications of particular embodiments thereof. Those skilled in the art will envision many other possible variations that are within the scope and spirit of the present invention.

What is claimed is:

1. A method for tuning an RFID label prior to application to an article comprising the steps of:
providing an RFID label having at least one antenna disposed therein;
identifying an article;
relaying information related to the identification of said article to a controller, said controller including a memory of pre-determined tuning parameters for said article;
retrieving from memory one or more of said tuning parameters for said article; and
adjusting the tuning parameters of said RFID label to correspond to said article by altering at least one geometric parameter of the at least one antenna of the RFID label.

2. A method according to claim 1, wherein the step of altering at least one geometric parameter includes altering at least one of a length, width and depth of the at least one antenna of the RFID label.

3. A method according to claim 1, wherein the step of altering at least one geometric parameter is performed by at least one of (a) mechanically cutting; (b) punching; and (c) ablating.

4. A method according to claim 1, further comprising the steps of:
measuring a response of said RFID label;
providing feedback to said controller to further adjust said tuning parameter by further altering at least one geometric parameter of the at least one antenna; and
repeating said measuring step until a desired tuning effect is achieved.

5. A method according to claim 1, wherein the step of retrieving one or more of said tuning parameters for said article is performed by reading the RFID label via a near field antenna assembly.

6. A method according to claim 1, wherein following the step of providing an RFID label having at least one antenna disposed therein, the method further comprises the step of:
providing a laser for altering said at least one geometric parameter of said at least one antenna.

7. A system for tuning an RFID label prior to application to an article, the system comprising:
a controller which receives identifying information for said article, said controller having a memory of pre-determined tuning parameters for said article,
said controller retrieving from memory one or more of said tuning parameters for said article; and
a cutting device configured to adjust the tuning parameters of said RFID label to correspond to said article by removing material from at least one antenna forming part of said RFID label.

8. A system according to claim 7, further comprising:
an article identification vision system which provides the identifying information to the controller.

9. A system according to claim 7, further comprising:
a tuning indicator which measures a response of said RFID label and providing feedback to said controller to further adjust said tuning parameter by removing additional material from the at least one antenna.

10. A system according to claim 9, wherein the tuning indicator is operatively coupled to a near field antenna, the near field antenna in proximity to the tag such that the antenna measures the response of the tag.

11. A system according to claim 10, wherein the near field antenna comprises a linear monopole microstrip assembly.

12. A system according to claim 10, wherein the near field antenna comprises a meanderline monopole microstrip assembly.
